(19) United States
(12) Patent Application Publication
(10) Pub. No.: US 2006/0133724 A1
(43) Pub. Date: Jun. 22, 2006

(54) Piezoelectric optical micro-switch structure

(75) Inventors: Shyh-Chour Huang, Kaohsiung (TW); Guh-Jyhjei Lan, Ta-Ya Hsiang (TW)

Correspondence Address: NIKOLAI & MERSEREAU, P.A., 900 SECOND AVENUE SOUTH, SUITE 820, MINNEAPOLIS, MN, 55402, US

(73) Assignees: National Kaohsiung University of Applied Sciences, Kaohsiung (TW); Shyh-Chour Huang, Kaohsiung (TW); Guh-Jyhjei Lan, Ta-Ya Hsiang (TW)

(21) Appl. No.: 11/017,352

(22) Filed: Dec. 20, 2004

(51) Int. Cl. G02B 6/26; G02B 6/42

(52) U.S. Cl. 385/18

(57) ABSTRACT

A piezoelectric optical micro-switch structure includes a base unit, a first cantilevered arm base, a first piezoelectric controller, a second cantilevered arm base, a second piezoelectric controller and an optical reflector. The base unit bears the first cantilevered arm base and the second cantilevered arm base each of which has a first cantilevered arm and a second cantilevered arm. The first piezoelectric controller and the second piezoelectric controller are correspondingly attached to the first cantilevered arm and the second cantilevered arm and used to control bending angles of the first cantilevered arm and the second cantilevered arm. Connected between the first cantilevered arm and the second cantilevered arm is the optical reflector. When one of the first cantilevered arm and the second cantilevered arm is bent, the optical reflector can change a reflective direction of incident light.

### BACKGROUND OF THE INVENTION

1. Field of the Invention

The present invention relates to a piezoelectric optical micro-switch structure. More particularly, the present invention relates to the piezoelectric optical micro-switch structure having a piezoelectric controller for controlling a bending angle of at least one cantilevered arm which may create an angular movement of an optical reflector and change a reflective direction of incident light.

2. Description of the Related Art

Generally, piezoelectricity material has electric charges which can be polarized to perform a piezoelectric phenomenon when a predetermined stress acts on the piezoelectricity material by an external force. Changes in degrees of polarization are proportional to stressed forces unless the stressed forces are slight adequately. Contrarily, a mechanical deformation of piezoelectricity material can be provided when a predetermined voltage acts on the piezoelectricity material. Once the piezoelectricity material is placed in an electric field, electric charges of the piezoelectricity material may be forced and moved a slight distance. Consequently, the piezoelectricity material creates slight expansion and contraction of the entire crystals so-called “electrostriction effect.”

Currently, features of polarization and mechanical deformation have been typically applied to the piezoelectricity material in converting electric energy into mechanical energy, or converting mechanical energy into electric energy.

The piezoelectricity material basically has three major parameters, including strain, stress and electric field of polarization adapted to determine features of the piezoelectricity material. Generally, all ferroelectric materials pertain to piezoelectricity material. Furthermore, the piezoelectricity material encompasses a part of non-ferroelectric material—quartz for example. The piezoelectricity material is widely used in industry in converting electric signals into mechanical signals, such as high frequency filter, intermediate frequency filter, acoustic transducer and ultrasonic transducer. Particularly, the piezoelectricity material is also used in optoelectronics industry such that features of the piezoelectricity material can control a mechanical movement of an optical element. European Patent No. 0825467 discloses an array of M×N thin film actuated mirrors. Each of the actuating structure includes a first thin film electrode, a thin film electrodisplacive member and a second thin film electrode. The thin film electrodisplacive member is made of piezoelectricity material. However, the array of M×N thin film actuated mirrors is only suitable in applying to an optical projection system that is unsuitable for use in an optical micro-switch structure.

European Patent No. 1243966 discloses a light-beam deflecting device including a photonic crystal and a deflection controller. The photonic crystal is made of two light-refractive materials having two different refractive indexes. The photonic crystal includes a light-incident side and an opposite light-emitting side. The deflection controller includes an external-force applying means for applying an external force as the energy to the photonic crystal. Thereby, the deflection controller is able to control the ratio of the refractive indexes of the photonic crystal. The external-force applying means is selectively made of the piezoelectricity material which is disposed at opposite sides of the photonic crystal such that the ratio of the refractive indexes of the photonic crystal can be adjusted for the purpose of refractive operation. The light-beam deflecting device of European Patent No. 1243966 constitutes an optical switch and further includes an optical input terminal and at least two optical output terminals. The optical input terminal is disposed at the light-incident side of the photonic crystal and adapted to transmit a light beam to the light-incident side of the photonic crystal. Correspondingly, the optical output terminals are disposed at the opposite light-emitting side of the photonic crystal and adapted to receive the penetrated light beam from light-emitting side of the photonic crystal. The deflection controller can control the ratio of the refractive indexes of the photonic crystal. Consequently, the light beam from the optical input terminal can be selectively transmitted to the predetermined optical output terminal.

However, there exist several drawbacks of the light-beam deflecting device of European Patent No. 1243966. The light-refractive materials of the photonic crystal with two different refractive indexes not only complicate the light-beam deflecting device, but also increase total manufacture cost for adjusting the ratio of the refractive indexes of the photonic crystal. Hence, there is a need for simplifying the structure of the photonic crystal and further reducing manufacture cost of the light-beam deflecting device. The present invention intends to provide a piezoelectric optical micro-switch structure having a piezoelectric controller for controlling a bending angle of at least one cantilevered arm which may create an angular movement of an optical reflector and change a reflective direction of incident light. The combination of piezoelectric controller with the cantilevered arm commonly simplifies the piezoelectric optical micro-switch structure in such a way to mitigate and overcome the above problem.

### SUMMARY OF THE INVENTION

The primary objective of this invention is to provide a piezoelectric optical micro-switch structure having a piezoelectric controller for controlling a bending angle of at least one cantilevered arm. The combination of piezoelectric controller with the cantilevered arm has a simplified structure which causes an angular movement of an optical reflector which changes a reflective direction of incident light. The secondary objective of this invention is to provide the piezoelectric optical micro-switch structure employing the piezoelectric controller for controlling the cantilevered arm and the optical reflector. The optical reflector reduces manufacture cost of the piezoelectric optical micro-switch structure.

The piezoelectric optical micro-switch structure in accordance with the present invention includes a base unit, a first cantilevered arm base, a first piezoelectric controller, a second cantilevered arm base, a second piezoelectric controller and an optical reflector. The base unit bears the first cantilevered arm base and the second cantilevered arm base. The first cantilevered arm base and the second cantilevered arm base has a first cantilevered arm and a second cantilevered arm respectively. The first piezoelectric controller and the second piezoelectric controller are correspondingly attached to the first cantilevered arm and the second cantilevered arm such that the first piezoelectric controller and the second piezoelectric controller can commonly control bending angles of the first cantilevered arm and the second cantilevered arm. Connected between the first cantilevered arm and the second cantilevered arm is the optical reflector. When one of the first cantilevered arm and the second cantilevered arm is bent, the optical reflector can change a reflective direction of incident light for switching operation.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is a perspective view of a piezoelectric optical micro-switch structure in accordance with a preferred embodiment of the present invention;

FIG. 2 is an elevational side view of the a piezoelectric optical micro-switch structure in accordance with the preferred embodiment of the present invention;

FIG. 3 is an elevational side view of the piezoelectric optical micro-switch structure performing a switching operation in accordance with the preferred embodiment of the present invention; and

FIG. 4 is an elevational side view of the piezoelectric optical micro-switch structure performing alternative switching operation in accordance with the preferred embodiment of the present invention.

### DETAILED DESCRIPTION OF THE INVENTION

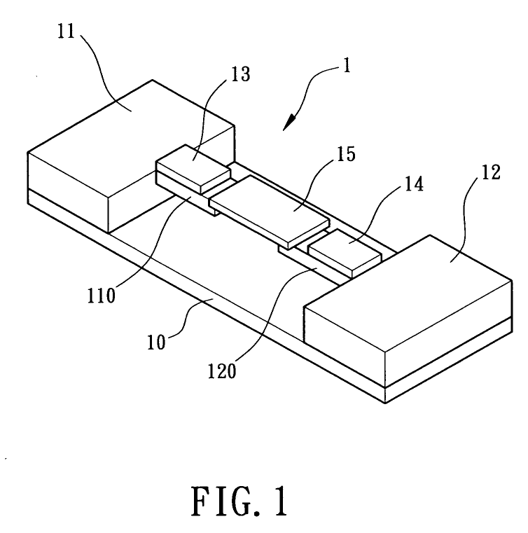

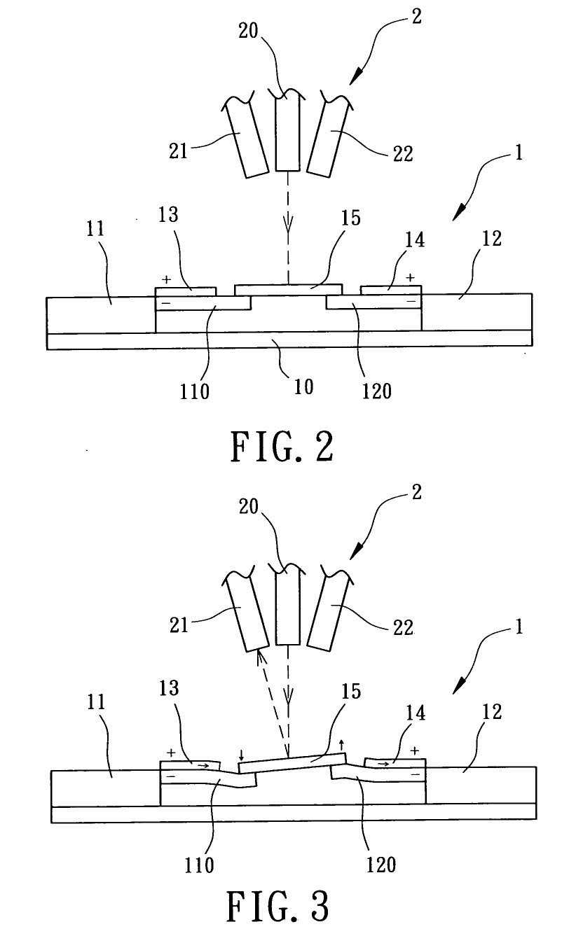

Referring initially to FIGS. 1 and 2, a piezoelectric optical micro-switch structure in accordance with the present invention constitutes an optical micro-switch designated numeral 1. The optical micro-switch 1 includes a base unit 10, a first cantilevered arm base 11, a second cantilevered arm base 12, a first piezoelectric controller 13, a second piezoelectric controller 14 and an optical reflector 15.

Still referring to FIGS. 1 and 2, the construction of the base unit 10 shall be described in detail. The base unit 10 is an elongated member which has a relatively thin layer with a predetermined thickness. Preferably, the base unit 10 is made of silicon or semiconductor material. The base unit 10 bears the first cantilevered arm base 11 and the second cantilevered arm base 12. The first cantilevered arm base 11 and the second cantilevered arm base 12 are located at either end of the base unit 10, and spaced apart a predetermined distance from each other.

Still referring to FIGS. 1 and 2, the construction of the cantilevered arm bases 11, 12 shall be described in detail. The cantilevered arm base 11 is aligned with the second cantilevered arm base 12 with respect to a longitudinal direction of the base unit 10. Preferably, the cantilevered arm bases 11, 12 are made of photoresist material, such as SU-8 photosensitive material, which permits structural deformation in operation. The first cantilevered arm base 11 and the second cantilevered arm base 12 has a first cantilevered arm 110 and a second cantilevered arm 120 respectively. In operation, both of the first cantilevered arm 110 and the second cantilevered arm 120 are deformable. The first cantilevered arm 110 is horizontally extending from the first cantilevered arm base 11 while the second cantilevered arm base 12 horizontally extending from the second cantilevered arm base 12. An end of the first cantilevered arm 110 is proximate to and not in contact with that of the second cantilevered arm 120. Consequently, remained between the first cantilevered arm 110 and the second cantilevered arm 120 is a predetermined distance.

Still referring to FIGS. 1 and 2, the construction of the piezoelectric controllers 13, 14 shall be described in detail. The first piezoelectric controller 13 and the second piezoelectric controller 14 are correspondingly adhered to upper surfaces of the first cantilevered arm 110 and the second cantilevered arm 120 so as to control mechanical movements of the first cantilevered arm 110 and the second cantilevered arm 120. Consequently, the first piezoelectric controller 13 and the second piezoelectric controller 14 can roughly control bending angles of the first cantilevered arm 110 and the second cantilevered arm 120, such as upwardly bending or downwardly bending, in outputting the mechanical movements.

Turning now to FIGS. 2 and 3, both of the first piezoelectric controller 13 and the second piezoelectric controller 14 have the same predetermined length that permits the mechanical movements ranging in a predetermined scope. Namely, each of the first cantilevered arm 110 and the second cantilevered arm 120 can output an expected movement. The first piezoelectric controller 13 and the second piezoelectric controller 14 are made of thick-film piezoelectric material, Lead Zirconate Titanate (PZT) for example. Each of the piezoelectric controllers 13, 14 has a positive electrode denoted by “+” and a negative electrode denoted by “−.” The distributions of the electrodes of the first piezoelectric controller 13 are same with those of the second piezoelectric controller 14. For example, the positive electrode of the first piezoelectric controller 13 is disposed at its upper portion such that the positive electrode of the second piezoelectric controller 14 is also disposed at its upper portion. In an alternative embodiment, the positive electrode of the first piezoelectric controller 13 is selectively disposed at its lower portion such that the positive electrode of the second piezoelectric controller 14 is also disposed at its lower portion.

Referring again to FIG. 2, the construction of the optical reflector 15 shall be described in detail. The optical reflector 15 is an aluminum reflector adapted to reflect a light beam to constitute an optical element. Preferably, the aluminum reflector has a mirror-finished surface at its front side. In this illustrated embodiment, the optical micro-switch 1 is combined with an optical fiber apparatus 2 and applied thereto such that the optical micro-switch 1 can control a switching operation of the optical fiber apparatus 2. The optical fiber apparatus 2 includes an optical output terminal 20, a first optical input terminal 21 and a second optical input terminal 22 which are arranged in a staggered manner. The optical output terminal 20 is used to emit a light beam to the optical reflector 15. Correspondingly, the optical input terminals 21, 22 are used to receive a light beam reflected from the optical reflector 15. The first cantilevered arm 110 and the second cantilevered arm 120 are commonly connected with two opposite ends of the optical reflector 15 so that they support the optical reflector 15 in structure. Preferably, the first cantilevered arm 110 and the second cantilevered arm 120 are adhered to the opposite ends of the optical reflector 15. In switching operation, the first cantilevered arm 110 and the second cantilevered arm 120 can control the optical reflector 15 for turning a predetermined angle.

Referring again to FIG. 3, the electric operation of the piezoelectric controllers 13, 14 shall be described in detail. Preferably, when an AC voltage ranging between 200VAC and 300VAC is applied to first piezoelectric controller 13 and the second piezoelectric controller 14, the first piezoelectric controller 13 and the second piezoelectric controller 14 may be horizontally extended or retracted a distance.

Still referring to FIG. 3, the optical output terminal 20 of the optical fiber apparatus 2 transmits a light beam to the optical reflector 15 which reflects the light beam to the first optical input terminal 21. In switching operation, when the positive and negative electrodes of the first piezoelectric controller 13 are supplied with opposite electrodes of a power system (not shown), the first piezoelectric controller 13 extends a distance to the right side indicated as an arrow at region of the piezoelectric controller 13. Similarly, when the positive and negative electrodes of the second piezoelectric controller 14 are supplied with the same electrodes of the power system (not shown), the second piezoelectric controller 14 retracts a distance to the right side indicated as an arrow at region of the piezoelectric controller 14. When the first piezoelectric controller 13 is extended a distance to cause a mechanical deformation, the first cantilevered arm 110 and the first piezoelectric controller 13 are mismatched since the first cantilevered arm 110 is an unextended member. Finally, the first piezoelectric controller 13 causes a downwardly bending movement of the first cantilevered arm 110. Contrarily, when the second piezoelectric controller 14 is retracted a distance to cause a mechanical deformation, the second cantilevered arm 120 and the second piezoelectric controller 14 are mismatched since the second cantilevered arm 120 is an unextended member. Finally, the second piezoelectric controller 14 causes an upwardly bending movement of the second cantilevered arm 120.

Referring back to FIG. 2, once the electrodes of the first and second piezoelectric controllers 13 and 14 are subsequently unelectrified, the mechanical deformations of the first and second piezoelectric controllers 13 and 14 are removed. Meanwhile, the first cantilevered arm 110 and the second cantilevered arm 120 are commonly returned to the original positions with respect to a horizontal direction.

Referring again to FIG. 3, the optical reflector 15 may be turned a predetermined angle when the first cantilevered arm 110 generates the downwardly bending movement and the second cantilevered arm 12 generates the upwardly bending movement. The optical reflector 15 is correspondingly inclined a predetermined angle to the base unit 10. Consequently, the optical reflector 15 reflects the light beam emitted from the optical output terminal 20 to the first optical input terminal 21.

Referring back to FIG. 2, the optical reflector 15 is returned to a horizontal position with respect to the base unit 10 once the first cantilevered arm 110 and the second cantilevered arm 120 are commonly returned to the original positions. Consequently, the optical reflector 15 switches off the light beam emitted from the optical output terminal 20 from the first optical input terminal 21.

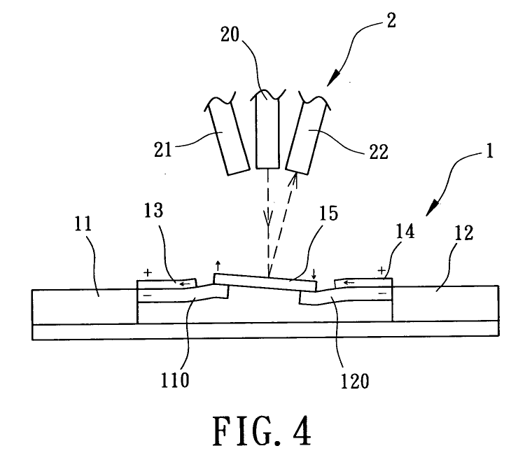

Turning now to FIG. 4, the optical output terminal 20 of the optical fiber apparatus 2 transmits a light beam to the optical reflector 15 which reflects the light beam to the second optical input terminal 22. In alternative switching operation, when the positive and negative electrodes of the first piezoelectric controller 13 are supplied with the same electrodes of a power system (not shown), the first piezoelectric controller 13 retracts a distance to the left side indicated as an arrow at region of the piezoelectric controller 13. Similarly, when the positive and negative electrodes of the second piezoelectric controller 14 are supplied with opposite electrodes of the power system (not shown), the second piezoelectric controller 14 extracts a distance to the left side indicated as an arrow at region of the piezoelectric controller 14. When the first piezoelectric controller 13 is extended a distance to cause a mechanical deformation, the first cantilevered arm 110 and the first piezoelectric controller 13 are mismatched since the first cantilevered arm 110 is an unextended member. Finally, the first piezoelectric controller 13 causes an upwardly bending movement of the first cantilevered arm 110. Contrarily, when the second piezoelectric controller 14 is retracted a distance to cause a mechanical deformation, the second cantilevered arm 120 and the second piezoelectric controller 14 are mismatched since the second cantilevered arm 120 is an unextended member. Finally, the second piezoelectric controller 14 causes a downwardly bending movement of the second cantilevered arm 120.

Referring back to FIG. 2, as has been discussed, once the electrodes of the first and second piezoelectric controllers 13 and 14 are subsequently unelectrified, the mechanical deformations of the first and second piezoelectric controllers 13 and 14 are also removed. Meanwhile, the first cantilevered arm 110 and the second cantilevered arm 120 are commonly returned to the original positions with respect to a horizontal direction.

Referring again to FIG. 4, the optical reflector 15 may be turned a predetermined angle when the first cantilevered arm 110 generates the upwardly bending movement and the second cantilevered arm 12 generates the downwardly bending movement. The optical reflector 15 is correspondingly inclined a predetermined angle to the base unit 10. Consequently, the optical reflector 15 reflects the light beam emitted from the optical output terminal 20 to the second optical input terminal 22.

Referring back to FIG. 2, the optical reflector 15 is returned to a horizontal position with respect to the base unit 10 once the first cantilevered arm 110 and the second cantilevered arm 120 are commonly returned to the original positions. Consequently, the optical reflector 15 switches off the light beam emitted from the optical output terminal 20 from the second optical input terminal 22.

In a modified embodiment, the optical micro-switch 1 can selectively adopt a single piezoelectric controller which is arranged on one of the first cantilevered arm base 11 and the second cantilevered arm base 12. The single piezoelectric controller may simplified the entire structure of the optical micro-switch 1. The piezoelectric controller can control one cantilevered arm of the cantilevered arm bases 11 and 12, and cause an upwardly bending movement or a downwardly bending movement. However, the other cantilevered arm of the cantilevered arm bases 11 and 12 does not require generating a mechanical movement. Consequently, the single piezoelectric controller can also control the optical reflector 15 for turning a predetermined angle in switching operation.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A piezoelectric optical micro-switch structure comprising:
a base unit;
a first cantilevered arm base arranged on the base unit, said first cantilevered arm base is provided with a first cantilevered arm which generates a mechanical deformation;
a second cantilevered arm base arranged on the base unit and spaced apart a predetermined distance from the first cantilevered arm base, said second cantilevered arm base is provided with a second cantilevered arm which generates a mechanical deformation;
a first piezoelectric controller including a pair of electrodes, said first piezoelectric controller is adhered to the first cantilevered arm so as to control the mechanical deformation of the first cantilevered arm;
a second piezoelectric controller including a pair of electrodes, said second piezoelectric controller is adhered to the second cantilevered arm so as to control the mechanical deformation of the second cantilevered arm; and
an optical reflector having a mirror surface at a front side, said optical reflector is connected between the first cantilevered arm and the second first cantilevered arm to constitute an optical micro-switch;
wherein when the first cantilevered arm and the second cantilevered arm are bent, the optical reflector can turn a predetermined bending angle and change a reflective direction of an incident light beam.

2. The piezoelectric optical micro-switch structure as defined in claim 1, wherein the base unit is made of silicon material.

3. The piezoelectric optical micro-switch structure as defined in claim 1, wherein the base unit is an elongated member so that the first cantilevered arm base and the second cantilevered arm base are disposed at opposite ends of the base unit.

4. The piezoelectric optical micro-switch structure as defined in claim 1, wherein the first cantilevered arm base and the second cantilevered arm base are made of photoresist material.

5. The piezoelectric optical micro-switch structure as defined in claim 1, wherein the first cantilevered arm and the second cantilevered arm are horizontally extending from the first cantilevered arm base and the second cantilevered arm base.

6. The piezoelectric optical micro-switch structure as defined in claim 1, wherein the first piezoelectric controller and the second piezoelectric controller are made of thick-film Lead Zirconate Titanate (PZT).

7. The piezoelectric optical micro-switch structure as defined in claim 1, wherein when positive and negative electrodes of one of the first piezoelectric controller and the second piezoelectric controller are supplied with opposite electrodes of a power system, one of the first piezoelectric controller and the second piezoelectric controller extends a distance such that one of the corresponding cantilevered arms and the corresponding piezoelectric controller are mismatched to cause a downwardly bending movement of the corresponding cantilevered arm.

8. The piezoelectric optical micro-switch structure as defined in claim 1, wherein when positive and negative electrodes of one of the first piezoelectric controller and the second piezoelectric controller are supplied with the same electrodes of a power system, one of the first piezoelectric controller and the second piezoelectric controller retracts a distance such that one of the corresponding cantilevered arms and the corresponding piezoelectric controller are mismatched to cause an upwardly bending movement of the corresponding cantilevered arm.

9. The piezoelectric optical micro-switch structure as defined in claim 1, wherein the optical reflector is an aluminum reflector.

10. The piezoelectric optical micro-switch structure as defined in claim 1, wherein the optical micro-switch is applied to an optical fiber apparatus which includes at least one optical output terminal and at least one optical input terminal.

11. A piezoelectric optical micro-switch structure comprising:
a base unit;
a first cantilevered arm base arranged on the base unit, said first cantilevered arm base is provided with a first cantilevered arm which generates a mechanical deformation;
a second cantilevered arm base arranged on the base unit and spaced apart a predetermined distance from the first cantilevered arm base, said second cantilevered arm base is provided with a second cantilevered arm which generates a mechanical deformation;
a piezoelectric controller including a pair of electrodes, said piezoelectric controller is adhered to the first cantilevered arm so as to control the mechanical deformation of the first cantilevered arm; and
an optical reflector having a mirror surface at a front side, said optical reflector is connected between the first cantilevered arm and the second first cantilevered arm to constitute an optical micro-switch;
wherein when the first cantilevered arm and the second cantilevered arm are bent, the optical reflector can turn a predetermined bending angle and change a reflective direction of an incident light beam.

12. The piezoelectric optical micro-switch structure as defined in claim 11, wherein the base unit is made of silicon material.

13. The piezoelectric optical micro-switch structure as defined in claim 11, wherein the base unit is an elongated member so that the first cantilevered arm base and the second cantilevered arm base are disposed at opposite ends of the base unit.

14. The piezoelectric optical micro-switch structure as defined in claim 11, wherein the first cantilevered arm base and the second cantilevered arm base are made of photoresist material.

15. The piezoelectric optical micro-switch structure as defined in claim 11, wherein the first cantilevered arm and the second cantilevered arm are horizontally extending from the first cantilevered arm base and the second cantilevered arm base.

16. The piezoelectric optical micro-switch structure as defined in claim 11, wherein the piezoelectric controller is made of thick-film Lead Zirconate Titanate (PZT).

17. The piezoelectric optical micro-switch structure as defined in claim 11, wherein when positive and negative electrodes of the piezoelectric controller is supplied with opposite electrodes of a power system, the piezoelectric controller extends a distance such that the first cantilevered arm and the piezoelectric controller are mismatched to cause a downwardly bending movement of the first cantilevered arm.

18. The piezoelectric optical micro-switch structure as defined in claim 11, wherein when positive and negative electrodes of the piezoelectric controller is supplied with the same electrodes of a power system, the piezoelectric controller retracts a distance such that the first cantilevered arm and the piezoelectric controller are mismatched to cause an upwardly bending movement of the first cantilevered arm.

19. The piezoelectric optical micro-switch structure as defined in claim 11, wherein the optical reflector is an aluminum reflector.

20. The piezoelectric optical micro-switch structure as defined in claim 11, wherein the optical micro-switch is applied to an optical fiber apparatus which includes at least one optical output terminal and at least one optical input terminal.
